(19) United States
(12) Patent Application Publication
(10) Pub. No.: US 2014/0357334 A1
(43) Pub. Date: Dec. 4, 2014

(54) METHOD AND APPARATUS FOR IMPLEMENTING SIMULATED CARD GAME

(71) Applicant: TENCENT TECHNOLOGY (SHENZHEN) COMPANY LIMITED, Shenzhen (CN)

(72) Inventors: ZHUO GONG, Shenzhen (CN); ZHIYONG ZHUO, Shenzhen (CN); YIJU MOU, Shenzhen (CN); JUN LI, Shenzhen (CN); LIANG SHANG, Shenzhen (CN); XIN WANG, Shenzhen (CN)

(73) Assignee: TENCENT TECHNOLOGY (SHENZHEN) COMPANY LIMITED

(21) Appl. No.: 14/462,764

(22) Filed: Aug. 19, 2014

Related U.S. Application Data
(63) Continuation of application No. PCT/CN2014/075070, filed on Apr. 10, 2014.

(30) Foreign Application Priority Data
May 17, 2013 (CN) 201310183159.7

(51) Int. Cl. G07F 17/32

(52) U.S. Cl. CPC G07F 17/3293; G07F 17/326
USPC 463/11

(57) ABSTRACT

A method for implementing a simulated card game on a game terminal is provided. The method includes displaying multiple sets of game elements of the simulated card game on a game interface, where each set of game elements corresponds to a virtual character, and each set of game elements includes character elements and card elements that represent the corresponding virtual character. The method also includes receiving a card playing instruction corresponding to the virtual character and updating the card elements corresponding to the virtual character based on the card playing instruction. Further, the method includes determining the virtual character that plays highest value cards based on card game rules and cards played by virtual characters in a current turn and labeling the game elements corresponding to the virtual character that plays the highest value cards to distinguish other virtual characters.

### CROSS-REFERENCES TO RELATED APPLICATIONS

This application is a continuation application of PCT Patent Application No. PCT/CN2014/075070, filed on Apr. 10, 2014, which claims priority of Chinese Patent Application No. 201310183159.7, filed on May 17, 2013, the entire contents of which are incorporated by reference herein.

### FIELD OF THE INVENTION

The present invention generally relates to computerized data processing technologies and, more particularly, to a method and apparatus for implementing a simulated card game in a game terminal.

### BACKGROUND

Entertainment has become a very important part of our life in this era. A game is a participatory, interactive form of entertainment. This concept is relative to passive forms of entertainment, such as watching TV, reading books, and watching movies. In the passive forms of entertainment, the entertainment that is presented to the audience and the audience role is passive. Games are more complicated. When playing a game, people may gain happiness through actively participating in the game.

With the development of computer and graphics technologies, video games have emerged as one of the most popular forms of entertainment. A video game is a game that employs electronics to create an operating platform (also called a game terminal) with which players can play. Video games are different from traditional games. Traditional games require game props, such as chess pieces, poker chips, and so on. Video games are games that allow people to interact by controlling their game terminals.

In the Internet era, video games have become online games. Playing online games has become one of the most popular entertainment forms. Online games provide strong communication platforms between players, so that players may get plenty of virtual reality experience in the game, which is not provided in the traditional games. A player (or a game user) can play a virtual role on a game interface of a game terminal, playing the game with the game terminal or virtual characters acted by other players.

FIG. 1 illustrates a schematic diagram of an exemplary game interface in existing technologies. As shown in FIG. 1, in existing simulated card games (e.g., an upgrading game), after each virtual character corresponding to each player playing the card game, the cards played by each player are displayed on the game interface of the game terminal. However, the game interface does not inform the player which virtual character plays the highest value cards among all cards played by all players. If a player wants to know which virtual character plays the highest value cards in a current turn, the player needs to judge according to game rules in combination with his/her own experience. When the card type is too complex or the player is not familiar with the game rules, the player may make a wrong judgment, having adverse effects on the next turn.

The disclosed method and apparatus are directed to solve one or more problems set forth above and other problems.

### BRIEF SUMMARY OF THE DISCLOSURE

One aspect of the present disclosure includes a method for implementing a simulated card game on a game terminal. The method includes displaying multiple sets of game elements of the simulated card game on a game interface, where each set of game elements corresponds to a virtual character, and each set of game elements includes character elements and card elements that represent the corresponding virtual character. The method also includes receiving a card playing instruction corresponding to the virtual character and updating the card elements corresponding to the virtual character based on the received card playing instruction. Further, the method includes determining the virtual character that plays highest value cards based on card game rules and cards played by virtual characters in a current turn and labeling the game elements corresponding to the virtual character that plays the highest value cards to distinguish other virtual characters.

Another aspect of the present disclosure includes an apparatus for implementing a simulated card game in a game terminal. The apparatus includes a game element display module configured to display multiple sets of game elements of the simulated card game on a game interface, where each set of game elements corresponds to one virtual character, and each set of game elements includes character elements and card elements that represent the corresponding virtual character. The apparatus also includes a card element updating module configured to receive a card playing instruction corresponding to a virtual character, and update the card elements corresponding to the virtual character based on the received card playing instruction. Further, the apparatus includes a highest value card playing character labeling module configured to, based on preset game rules and cards played by all virtual characters in a current turn, determine the virtual character that plays highest value cards in the current turn, and label the game elements corresponding to the virtual character that plays the highest value cards to distinguish other virtual characters.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present disclosure, the figures which are needed to be used in the description of the present disclosure or the existing technology are briefly described in the following. Obviously, the figures in the following description are only some embodiments of the present disclosure, and it is easily for those skilled in the art to obtain other figures based on the following figures without creative work.

FIG. 1 illustrates a schematic diagram of an exemplary game interface in existing technologies;

FIG. 2 illustrates a flow chart of an exemplary process for implementing a simulated card game in a game terminal consistent with the disclosed embodiments;

FIG. 3 illustrates a schematic diagram of an exemplary game interface consistent with the disclosed embodiments;

FIG. 4 illustrates a schematic diagram of another exemplary game interface consistent with the disclosed embodiments;

FIG. 5 illustrates a schematic diagram of another exemplary game interface consistent with the disclosed embodiments;

FIG. 6 illustrates a schematic diagram of another exemplary game interface consistent with the disclosed embodiments;

FIG. 7 illustrates a schematic diagram of another exemplary game interface consistent with the disclosed embodiments;

FIG. 8 illustrates a schematic diagram of another exemplary game interface consistent with the disclosed embodiments;

FIG. 9 illustrates a flow chart of another exemplary process for implementing a simulated card game in a game terminal consistent with the disclosed embodiments;

FIG. 10 illustrates a flow chart of S25 in FIG. 9 consistent with the disclosed embodiments;

FIG. 11 illustrates a structure diagram of an exemplary apparatus for implementing a simulated card game in a game terminal consistent with the disclosed embodiments;

FIG. 12 illustrates a structure diagram of another exemplary apparatus for implementing a simulated card game in a game terminal consistent with the disclosed embodiments;

FIG. 13 shows an environment incorporating certain aspects of the present invention; and

FIG. 14 shows a block diagram of an exemplary computer system capable of implementing a simulated card game.

### DETAILED DESCRIPTION

Reference will now be made in detail to exemplary embodiments of the disclosure, which are illustrated in the accompanying drawings.

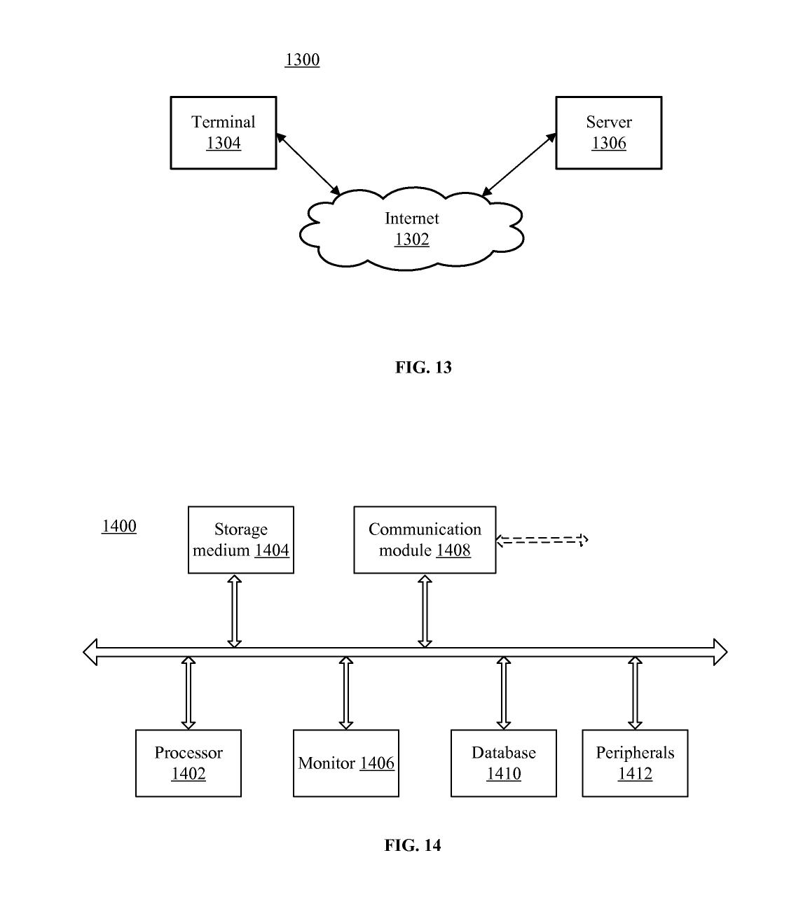

FIG. 13 shows an environment incorporating certain aspects of the present invention. As shown in FIG. 13, environment 1300 may include a terminal 1304, a server 1306, and the Internet 1302. The terminal 1304 may access the server 1306 through the Internet 1302 for certain personalized services provided by the server 1306. Although only one server 1306 and one terminal 1304 is shown in the environment 1300, any number of terminals 1304 or servers 1306 may be included, and other devices may also be included.

The Internet 1302 may include any appropriate type of communication network for providing network connections to the terminal 1304 and server 1306 or among multiple terminals 1304 and servers 1306. For example, Internet 1302 may include the Internet or other types of computer networks or telecommunication networks, either wired or wireless.

A terminal, as used herein, may refer to any appropriate user terminal with certain computing capabilities, such as a personal computer (PC), a work station computer, a gaming console or computer, a hand-held computing device (tablet), a smart phone or mobile phone, or any other user-side computing device. In certain embodiments, terminal 1304 may be a wireless terminal, such as a smart phone, a tablet computer, or a mobile phone, etc. Terminal 1304 may be implemented on any appropriate computing platform. For example, the terminal 1304 may run a browser or a gaming software program to play a card game online with other players.

A server, as used herein, may refer one or more server computers configured to provide certain web server functionalities to provide certain card game services. A server may also include one or more processors to execute computer programs in parallel.

FIG. 14 shows a block diagram of an exemplary computer system 1400 capable of implementing a simulated card game. As shown in FIG. 14, computer system 1400 may include a processor 1402, a storage medium 1404, a monitor 1406, a communication module 1408, a database 1410, and peripherals 1412. Certain devices may be omitted and other devices may be included.

Processor 1402 may include any appropriate processor or processors. Further, processor 1402 can include multiple cores for multi-thread or parallel processing. Storage medium 1404 may include memory modules, such as ROM, RAM, flash memory modules, and erasable and rewritable memory, and mass storages, such as CD-ROM, U-disk, and hard disk, etc. Storage medium 1404 may store computer programs for implementing various processes, when executed by processor 1402.

Further, peripherals 1412 may include I/O devices such as keyboard and mouse, and communication module 1408 may include network devices for establishing connections through the communication network. Database 1410 may include one or more databases for storing certain data and for performing certain operations on the stored data, such as database searching.

In operation, terminal 1404 and/or server 1406 may run a web browser or other applications to implement a simulated card game. That is, when the web browser or other applications are running on terminal 1404, multiple sets of game elements of the simulated card game are displayed on the game interface. A card playing instruction corresponding to one virtual character is received, and the card elements corresponding to the virtual character are updated based on the received card playing instruction. Based on preset game rules and cards played by each virtual character in a current turn, the virtual character that plays the highest value cards in the current turn is determined, and the game elements corresponding to the virtual character that plays the highest value cards are labeled, so that other virtual characters can be distinguished.

FIG. 2 illustrates a flow chart of an exemplary process for implementing a simulated card game in a game terminal consistent with the disclosed embodiments. As shown in FIG. 2, the process for implementing a simulated card game in a game terminal may include the following steps.

S11: multiple sets of game elements of the simulated card game are displayed on the game interface. Each set of game elements corresponds to a virtual character. Each set of game elements may include character elements or card elements that represent the corresponding virtual character.

A virtual character refers to a character in a simulated card game that is controlled by a player (or a game user). For example, in online card game called Shengji (up-a-grade), a virtual character refers to a user name registered by a player. In general, there are four virtual characters in the online Shengji card game.

A game interface refers to a user interface of a game client, including game design elements directly or indirectly contacted with the game user, such as buttons, animations, text, sound, windows on the game screen, etc.

In S11, at the beginning, multiple sets of game elements of the simulated card game are displayed on the game interface. Each set of game elements corresponds to a virtual character. Each set of game elements includes at least a character element and a card element that represent the corresponding virtual character. The character elements may include the virtual character's avatar, name, and so on. The card elements may include a card picture representing the card that the player plays in a current turn or a card picture representing the card that the player has not played in the current turn.

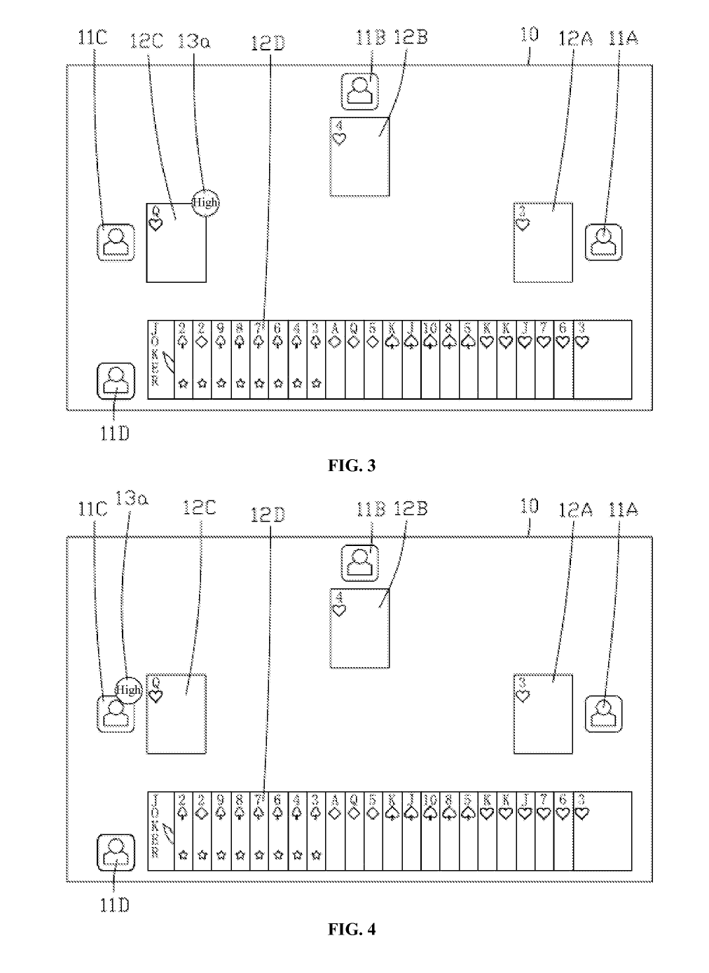

Specifically, a Shengji card game is a family of point trick-taking card games played in China. FIG. 3 illustrates a schematic diagram of an exemplary game interface 10 consistent with the disclosed embodiments. As shown in FIG. 3, it is assumed that there are 4 virtual characters A, B, C and D in the Shengji card game. Character elements corresponding to different virtual characters can be represented by the avatars used by the four players when registering the game, respectively. The character elements may also include users' names and other information used by the four players when registering the game. In the game interface 10, icons 11A, 11B, 11C and 11D represent character elements corresponding to the four virtual characters A, B, C, and D, respectively. Icons 12A, 12B, 12C and 12D represent card elements corresponding to the four virtual characters A, B, C and D, respectively. It should be noted that, in an actual design, because display screens of some game terminals are relatively small (e.g., cell phones), in order to save space of the game interface, the character element 11D may not be included. The actual implementation is not limited here.

S12: a card playing instruction corresponding to one virtual character is received, and the card elements corresponding to the virtual character are updated based on the card playing instruction.

The player (i.e., a game user) may send a card playing instruction through clicking the corresponding card picture on the game interface and clicking “play” button (not shown). When the card playing instruction corresponding to the virtual character sent from the player is received by the game client, the current card elements are updated based on the received card playing instruction. For example, when the player corresponding to the virtual character A clicks cards 9♡9♡8♡8♡ and clicks the “play” button, the game interface displays the cards 9♡9♡8♡8♡.

S13: based on preset game rules and cards played by each virtual character in the current turn, the virtual character that plays the highest value card(s) in the current turn is determined, and the game elements corresponding to the virtual character that plays the highest value cards are labeled, so that other virtual characters can be distinguished.

A turn refers to a round of play. For example, in the Shengji card game, four virtual characters, A, B, C and D, take turns playing cards at a time in a clockwise or counter-clockwise order. This is called one turn or one round of play. In one turn, or in one round of play, the virtual character that plays the cards first can be called the first virtual character. The first virtual character is the virtual character that starts every round.

The preset game rules can be stored in a game client or in a server. Based on the preset game rules and the cards played by the four virtual characters in the current turn, the game client or the server may determine the virtual character that plays the highest value cards in the current turn.

Specifically, it is assumed that the virtual character A is the first virtual character, and the virtual characters A, B, C, and D take turns playing the cards. After the virtual character A plays the cards, the virtual character B plays the cards, and the cards played by the virtual character B are compared with the cards played by the virtual character A. If the value of the cards played by the virtual character B is higher than the value of the cards played by the virtual character A, the virtual character B is determined as the virtual character that plays the highest value cards currently. After the virtual character C plays the cards, the cards played by the virtual character C are compared with the cards played by the virtual character B. If the value of the cards played by the virtual character B is higher than the value of the cards played by the virtual character C, the virtual character B is still determined as the virtual character that plays the highest value cards currently; if the value of the cards played by the virtual character C is higher than the value of the cards played by the virtual character B, the virtual character C is determined as the virtual character that plays the highest value cards currently, and so on.

After the virtual character that plays the highest value cards in the current turn is determined, the game client may label the game elements corresponding to the virtual character that plays the highest value cards, so that other virtual characters can be distinguished.

The label can be a graphical label. The forms of the graphical label are not limited here, as long as other virtual characters can be distinguished using contents, position, color, shape or texture of the graphical label.

The contents of the graphical label may include text. For example, a graphical label may include text “high” (the text “high” refers to the highest value card label). It should be understood, in certain embodiments of the present disclosure, the specific form of the “high” value card label can be changed. As long as the label can remind and inform the player the virtual character that plays the highest value cards currently, it is considered as an alternative label.

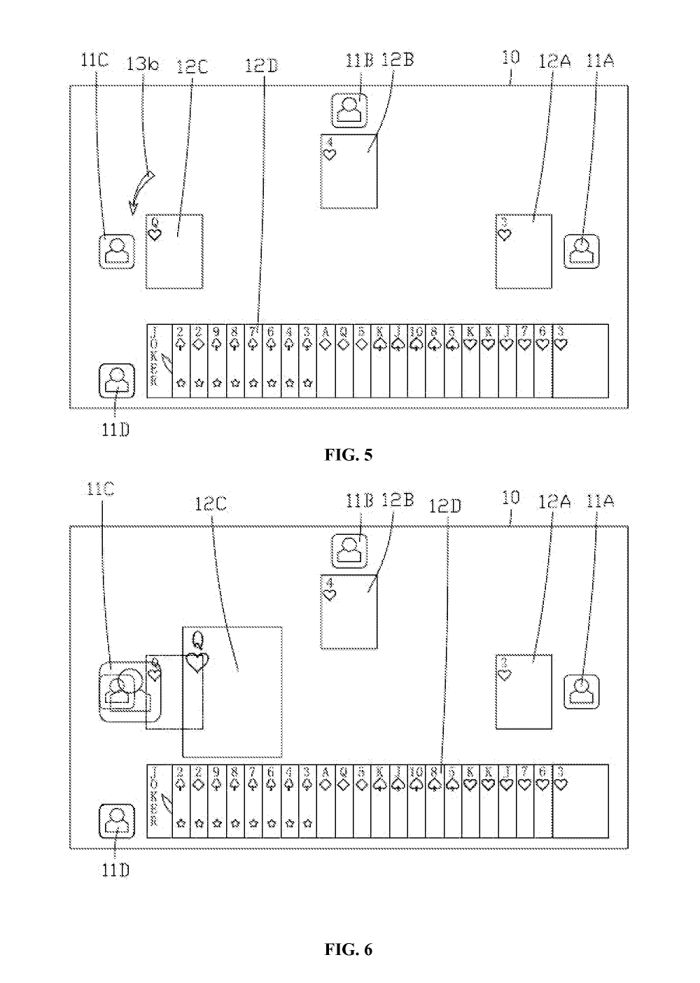

For example, the position, color, shape and embedded text of the highest value card label can be changed.
a. the position of the highest value card label is changed. For example, the label can be placed in the upper left, lower left, lower right and central part, or be placed on the corresponding character elements (avatar), and so on. As shown in FIG. 3, the highest value card label 13a is set in the upper right corner of a card element 12C corresponding to a virtual character C. FIG. 4 illustrates a schematic diagram of another exemplary game interface consistent with the disclosed embodiments. As shown in FIG. 4, a highest value card label 13a is set on a character element 11C corresponding to a virtual character C.
b. the color of the highest value card label is changed using the color that can be distinguished from the color of other elements on the game interface;
c. the shape of the highest value card label is changed using a square, a diamond, and other regular or irregular polygons and creating border and pattern;
d. the text “high” embedded in the highest value card label is replaced by other text that can indicate the highest value cards among cards played by the virtual characters (e.g., “strongest”, “highest”, etc.).

The graphical label may also include graphs. For example,
a. an arrow is used to point to the character elements or the card elements corresponding to the virtual character that plays the highest value cards in the current turn. FIG. 5 illustrates a schematic diagram of another exemplary game interface consistent with the disclosed embodiments. As shown in FIG. 5, an arrow 13b points to a character element 11C corresponding to a virtual character C;
b. a logo (e.g., an imperial crown) is marked on the character elements corresponding to the virtual character that plays the highest value cards, indicating that the virtual character plays the highest value cards.

The shape, size and color of the character elements or the card elements corresponding to the virtual character that plays the highest value cards can be changed, so that other virtual characters can be distinguished. That is, the game elements of the virtual character that plays the highest value cards are implicitly set different from the game elements of other virtual characters. Therefore, the player can distinguish the highest value card in the current turn. FIG. 6 illustrates a schematic diagram of another exemplary game interface consistent with the disclosed embodiments. As shown in FIG. 6, a virtual character C is labeled by increasing the size of the corresponding character element 11C and the corresponding card element 12C. A solid line represents the character element 11C and the card element 12C after enlargement, and a dashed line represents the character element 11C and the card element 12C before enlargement.

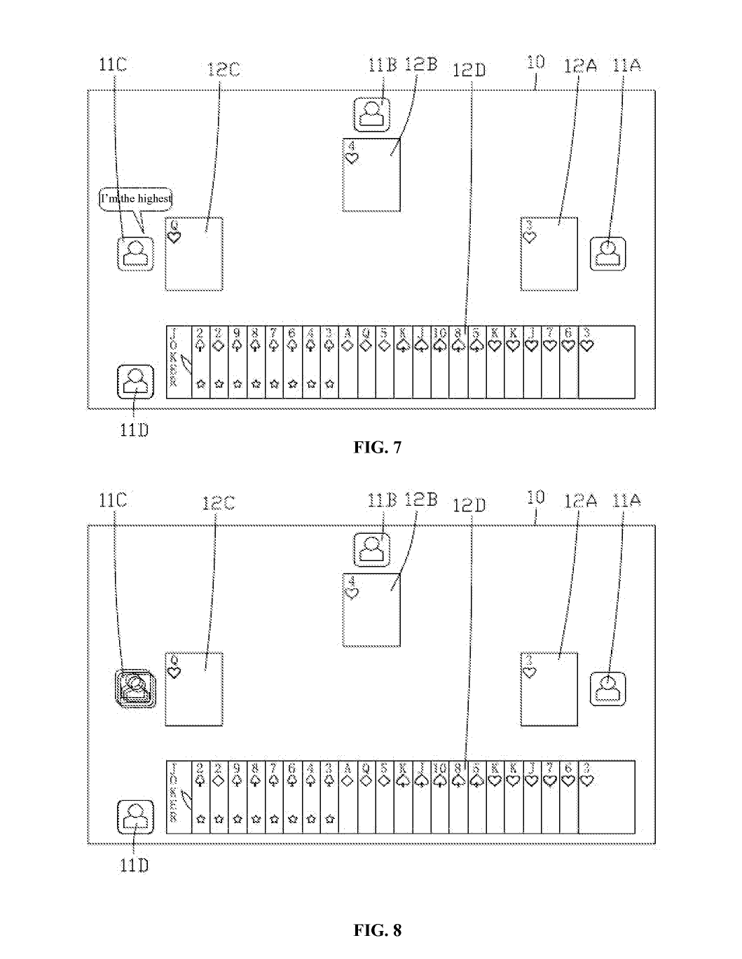

Sound effects (or audio effects) can also be used to inform the player the virtual character that plays the highest value cards in the current turn. That is, the label can be a sound label. For example, after the first virtual character plays the cards, if the value of the cards played by a subsequent virtual character is higher than the value of the cards played by the first virtual character, sound is played to inform the player the virtual character that plays the highest value cards in the current turn, such as “high”, “I am the highest”, and so on. FIG. 7 illustrates a schematic diagram of another exemplary game interface consistent with the disclosed embodiments. As shown in FIG. 7, a virtual character C is the virtual character that plays the highest value cards, sound “I am the highest” is played to label the virtual character C.

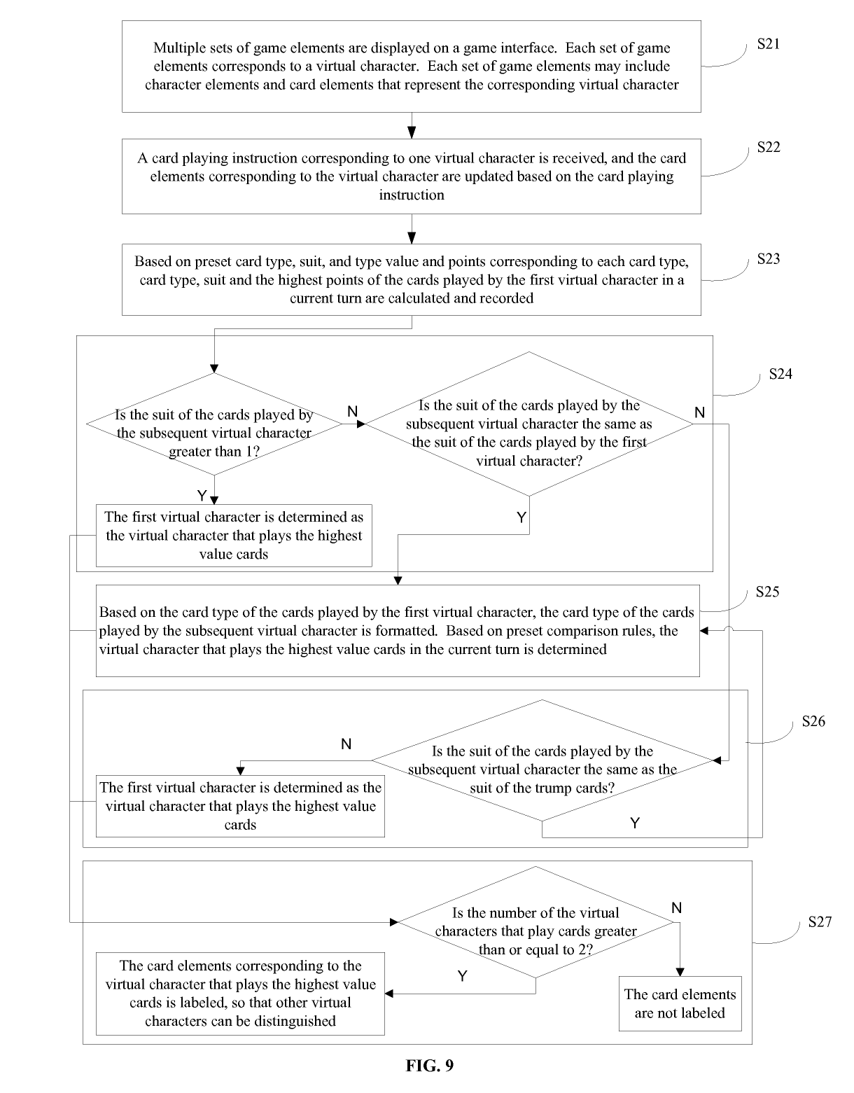

Animation effects can also be used to inform the player the virtual character that plays the highest value cards in the current turn. That is, the label can be an animation label. For example, after the first virtual character plays the cards, if the value of the cards played by the subsequent virtual character is higher than the value of the cards played by the first virtual character, an animation is played to inform the player the virtual character that plays the highest value cards in the current turn, such as a text animation “high”. The form of the animation is not limited here. FIG. 8 illustrates a schematic diagram of another exemplary game interface consistent with the disclosed embodiments. As shown in FIG. 8, a value of the cards played by a virtual character C is the highest, and the virtual character C is labeled through flashing the character element corresponding to the virtual character C.

It should be noted that the game interfaces shown in FIG. 3 to FIG. 8 are certain embodiments of the present disclosure. The forms of the label are not limited in the present disclosure. As long as the label can remind and inform the player the virtual character that plays the highest value cards, it is considered as an alternative label.

In addition, if the virtual character D (the last virtual character in the current turn) is determined as the virtual character that plays the highest value cards in the current turn, because the server can inform the game terminal that the virtual character D is the first virtual character to play the cards in a next turn and place an label “playing cards” on the game elements corresponding to the virtual character D. In this case, the label “playing cards” can also be used as the label indicating the virtual character that plays the highest value cards.

Comparing with current technologies, the method for implementing a simulated card game on a game terminal provided in the present disclosure can distinguish a virtual character that plays the highest value cards through labeling the game elements corresponding to the virtual character that plays the highest value cards. The method can clearly inform the player (i.e. game user) which virtual character plays the highest value cards in the current turn. Therefore, the user can quickly make a card playing decision for the next turn. The game interface is more user-friendly, and the user's interactive experience is enhanced.

FIG. 9 illustrates a flow chart of another exemplary process for implementing a simulated card game on a game terminal consistent with the disclosed embodiments. As shown in FIG. 9, the process for implementing the simulated card game on the game terminal may include the following steps.

S21: multiple sets of game elements are displayed on a game interface. Each set of game elements corresponds to a virtual character. Each set of game elements may include character elements and card elements that represent the corresponding virtual character.

S22: a card playing instruction corresponding to one virtual character is received, and the card elements corresponding to the virtual character are updated based on the card playing instruction.

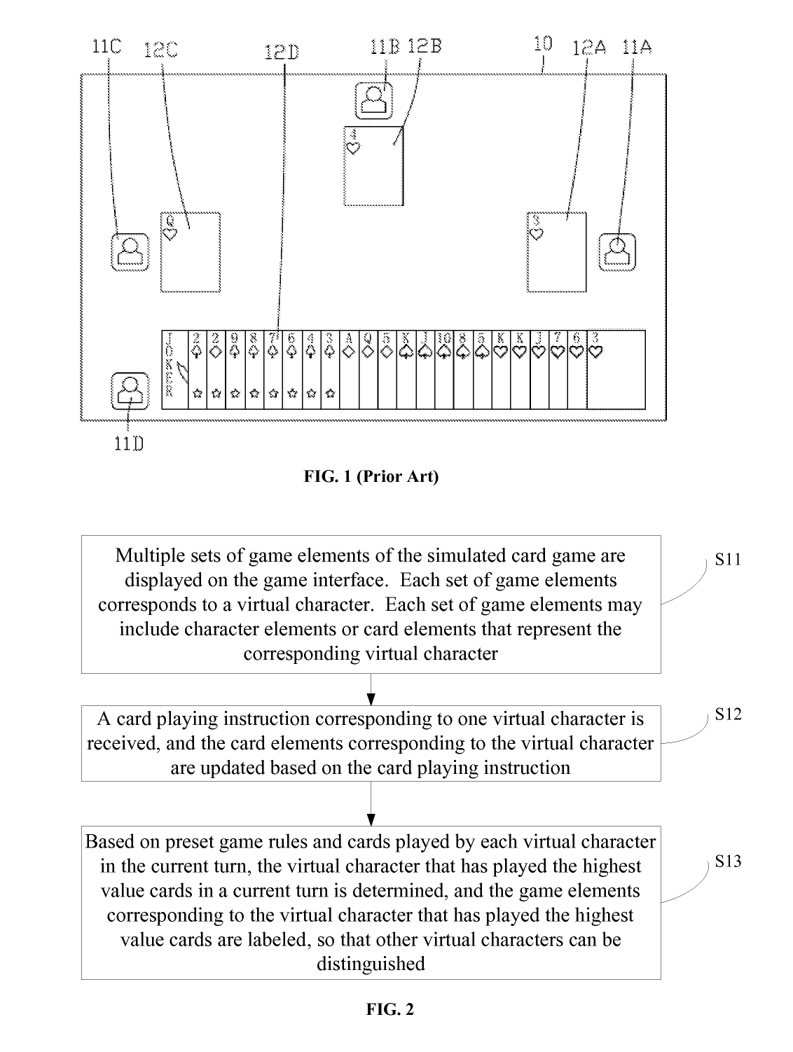

S21 and S22 can refer to S11 and S12 in the embodiments shown in FIG. 1, and the details of S21 and S22 are omitted herein.

S23: based on a preset card type, suit, and type value and points corresponding to each card type, the card type, suit and the highest points of the cards played by a first virtual character in a current turn are calculated and recorded.

In the online Shengji card game, the preset card type may include a single card (e.g., 5♦), a pair (e.g., 3 [symbol] 3 [symbol] ), consecutive double cards (e.g., 8 [symbol] 8 [symbol] 7 [symbol] 7 [symbol] ), and so on.

In playing the cards, a suit is one of several categories into which the cards of a deck are divided. There are four suits in a standard deck of cards: diamonds ♦, clubs [symbol] , spades [symbol] , and hearts ♡.

Different card types correspond to different preset type values. For example, a type value of a single card may be preset as 0, a type value of a pair may be preset as 1, and a type value of consecutive double cards may be preset as the number of pairs (e.g., the number of pairs in consecutive double cards A [symbol] A [symbol] K [symbol] K [symbol] is 2, its type value is 2; the number of pairs in consecutive double cards 9 [symbol] 9 [symbol] 8 [symbol] 8 [symbol] 7 [symbol] 7 [symbol] is 3, its type value is 3.).

The card points refer to the value of the card. The card points depend on the suit and rank of the card. Trumps are made during the deal, by a player exposing face up on the table a card of the dominant rank, or two identical cards of the dominant rank, or two identical jokers. The dominant suit is the suit of the exposed card. If identical jokers are exposed, there are no trumps (and the dominant rank has no special status in that deal). The dominant rank is equal to the score of the declarers in any particular turn. The dominant suit is determined during the drawing of cards, where any player decides to reveal a card in the dominant rank he/she has.

The typical order, from highest to lowest is big joker > small joker > cards in the dominant suit and rank > other cards in the dominant rank> non trump cards. For example, points of a non-dominant suit 2 to A can be set as 2 to 13, respectively. For trump cards, card points of the card in a dominant suit and a dominant rank can be set as 15; the card points of other cards in dominant rank can be set as 14.

In S23, based on the preset card type, suit, type value and card points corresponding to each card type, the card type, suit and the highest card points of the cards played by the first virtual character in the current turn are calculated and recorded. For example, when the first virtual character plays cards A [symbol] K [symbol] 9 [symbol] 9 [symbol] 8 [symbol] 8 [symbol] 3 [symbol] 3 [symbol] , the card type is a single card A [symbol] (the type value of the single card A [symbol] is 0), a single card K [symbol] (the type value of the single card K [symbol] is 0), a pair 3 [symbol] 3 [symbol] (the type value of the pair 3 [symbol] 3 [symbol] is 1), and consecutive double cards 9 [symbol] 9 [symbol] 8 [symbol] 8 [symbol] (the type value of the consecutive double cards 9 [symbol] 9 [symbol] 8 [symbol] 8 [symbol] is 2), where the highest card points for the single card is A; the highest card points for the pair is 3; and the highest card points for the consecutive double cards is 9.

S24: whether the suit type of the cards played by the subsequent virtual character is greater than 1 is determined. If the suit type of the cards played by the subsequent virtual character is greater than 1, the first virtual character is determined as the virtual character that plays the highest value cards. Otherwise, whether the suit of the cards played by the subsequent virtual character is the same as the suit of the cards played by the first virtual character is judged.

If the suit of the cards played by the subsequent virtual character is the same as the suit of the cards played by the first virtual character, the process goes to S25. If the suit of the cards played by the subsequent virtual character is not the same as the suit of the cards played by the first virtual character, the process goes to S26.

In S24, at the beginning, whether the suit type of the cards played by the subsequent virtual character is greater than 1 is determined. That is, whether the cards played by the subsequent virtual character are offsuit is determined. If the cards played by the subsequent virtual character are offsuit, the first virtual character is determined as the virtual character that plays the highest value cards. If the cards played by the subsequent virtual character are not offsuit, whether the suit of the cards played by the subsequent virtual character is the same as the suit of the cards played by the first virtual character is judged. If the suit of the cards played by the subsequent virtual character is not the same as the suit of the cards played by the first virtual character, the process goes to S26. If the suit of the cards played by the subsequent virtual character is the same as the suit of the cards played by the first virtual character, the process goes to S25. Otherwise, the first virtual character is determined as the virtual character that plays the highest value cards.

S25: based on the card type of the cards played by the first virtual character, the card type of the cards played by the subsequent virtual character is formatted. Based on preset comparison rules, the virtual character that plays the highest value cards in the current turn is determined.

In S25, based on the preset comparison rules, the virtual character that plays the highest value cards in the current turn is determined.

For example, if the cards played by the subsequent virtual character are Q [symbol] J [symbol] 5 [symbol] 5 [symbol] 4 [symbol] 4 [symbol] 7 [symbol] 6 [symbol] , based on the card type of the cards played by the first virtual character, the card type of the cards played by the subsequent virtual character is formatted. The obtained card type includes a single card Q [symbol] (the type value of the single card Q [symbol] is 0), a single card J [symbol] (the type value of the single card J [symbol] is 0), a single card 7 [symbol] (the type value of the single card 7 [symbol] is 0), a single card 6 [symbol] (the type value of the single card 6 [symbol] is 0), no pair, and consecutive double cards 5 [symbol] 5 [symbol] 4 [symbol] 4 [symbol] (the type value of the consecutive double cards 5 [symbol] 5 [symbol] 4 [symbol] 4 [symbol] is 2), where the highest card points for the single card is Q; the highest card points for the pair is 0; and the highest card points for the consecutive double cards is 5.

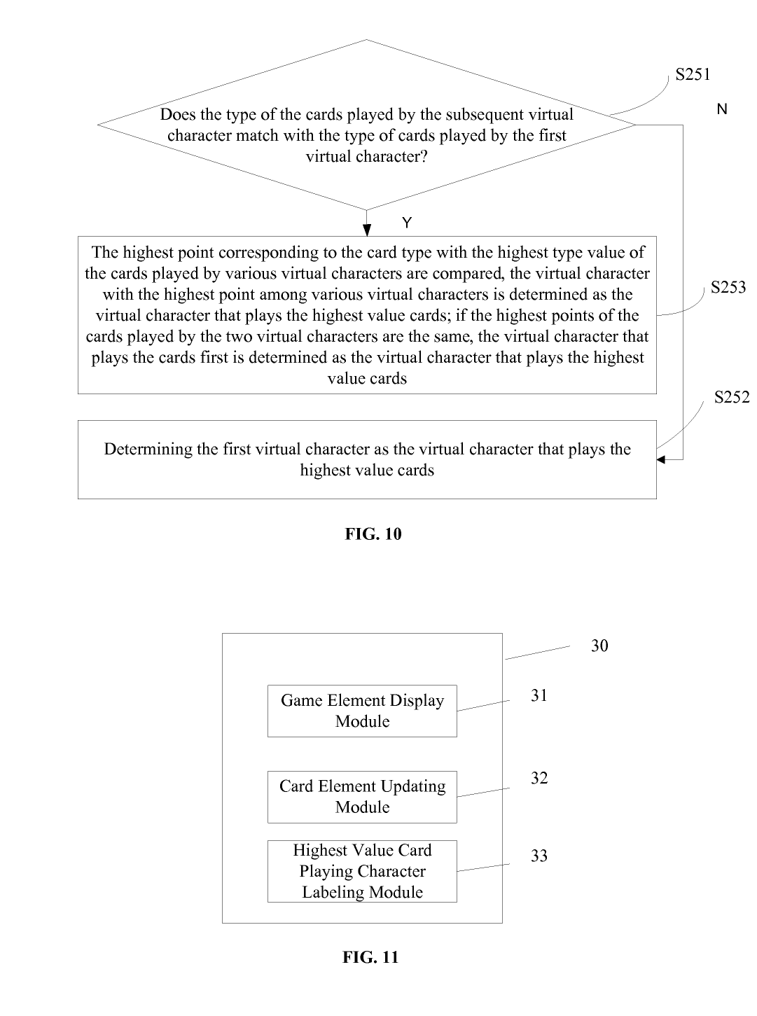

FIG. 10 illustrates a flow chart of S25 consistent with the disclosed embodiments. As shown in FIG. 10, based on preset comparison rules, the step for determining the virtual character that plays the highest value cards may further include the followings.

S251: whether the type of the cards played by the subsequent virtual character matches with the type of cards played by the first virtual character is determined. If the types of the cards played by the two virtual characters do not match, the process goes to S252; if the types of the cards played by the two virtual character match, the process goes to S253.

S252: the first virtual character is determined as the virtual character that plays the highest value cards.

S253: the highest point corresponding to the card type with the highest type value of the cards played by various virtual characters are compared, the virtual character with the highest point among various virtual characters is determined as the virtual character that plays the highest value cards. If the highest points of the cards played by the two virtual characters are the same, the virtual character that plays the cards first is determined as the virtual character that plays the highest value cards.

For example, the cards played by the first virtual character are A [symbol] K [symbol] 9 [symbol] 9 [symbol] 8 [symbol] 8 [symbol] 3 [symbol] 3 [symbol] , where the card type includes two single cards, a pair and consecutive double cards; and the cards played by the second virtual character are Q [symbol] J [symbol] 5 [symbol] 5 [symbol] 4 [symbol] 4 [symbol] 7 [symbol] 6 [symbol] , where the card type does not include a pair. Therefore, the types of the cards played by the two virtual characters do not match, and the first virtual character is determined as the virtual character that plays the highest value cards. If the cards played by the second virtual character are Q [symbol] J [symbol] 5 [symbol] 5 [symbol] 4 [symbol] 4 [symbol] 7 [symbol] 7 [symbol] , because the card type also includes two single cards, a pair and consecutive double cards, it is determined that the types of the cards played by the two virtual characters match. At this time, the highest points corresponding to the card type with the highest type value of the cards played by the two virtual characters are compared. The card type that has the highest type value is the consecutive double cards. For the cards played by the first virtual character, the highest point of the consecutive double cards is 9. For the cards played by the second virtual character, the highest point of the consecutive double cards is 5. Therefore, the first virtual character is determined as the virtual character that plays the highest value card.

S26: whether the suit of the cards played by the subsequent virtual character is the same as the suit of the trump cards is determined. If the suit of the cards played by the subsequent virtual character is the same as the suit of the trump cards, the process goes to S25; if the suit of the cards played by the subsequent virtual character is not the same as the suit of the trump cards, the first virtual character is determined as the virtual character that plays the highest value cards.

If the highest points of the highest value card type are the same, the virtual character that plays the cards first is determined as the virtual character that plays the highest value cards. If the suit of the cards played by the subsequent virtual character is the same as the suit of the trump cards, the virtual character that plays the highest value cards can also be determined according to S25.

In addition, for card point determination in the online Shengji card game, because there are trump cards, the default points of the card may be changed. For example, the trump cards include a big joker, a small joker, trump cards in the dominant suit and trump cards in the non-dominant suit. The typical order, from the highest to the lowest, is big joker > small joker > trump cards in the dominant suit > trump cards in the non-dominant suit> non-trump cards. The order of the card points for non-trump cards, from the highest to lowest, is A>K>Q>J>10>9>8>7>6>5>4>3>2. That is, the highest point is determined in combination with the preset game rules.

S27: whether the number of the virtual characters that play cards is greater than or equal to 2 is judged. If the number is greater than or equal to 2, the card elements corresponding to the virtual character that plays the highest value cards are labeled, so that other virtual characters can be distinguished. If the number is less than 2, the card elements are not labeled.

As used herein, after the virtual character that plays the highest value cards in the current turn is determined, whether the number of virtual characters that play the cards is greater than or equal to 2 can be further judged. If the number is greater than or equal to 2, the game elements corresponding to the virtual character that plays the highest value cards are labeled, so that other virtual characters can be distinguished; if the number is not greater than or equal to 2, the game elements corresponding to the virtual character that plays the highest value cards are not labeled. That is, if the number of the virtual characters that play the cards is less than 2 (i.e. the first virtual character is the only virtual character that plays the cards), the first virtual character is obviously the virtual character that plays the highest value cards and no special label is needed. Only after other virtual characters play the cards, the virtual character that plays the highest value cards is labeled.

The label can be a graphical label by using contents, position, color, shape and texture of the graphical label to distinguish other virtual characters. The label can be a sound label. The label can also be an animation label. The game elements of the virtual character that plays the highest value cards are labeled through changing shape, size or color of the character elements or the card elements. References may be made to the corresponding process in the method embodiments in FIGS. 2 to 8, and details are not described herein again.

Comparing with current technologies, the method for implementing a simulated card game on a game terminal in the present disclosure can distinguish a virtual character that plays a highest value cards through labeling the game elements corresponding to the virtual character that plays the highest value cards. The method can clearly inform the game user (player) which virtual character plays the highest value cards in a current turn. Therefore, the user can quickly make a card playing decision for the next turn. The game interface is more user-friendly, and the user's interactive experience is enhanced.

FIG. 11 illustrates a structure diagram of an exemplary apparatus for implementing a simulated card game in a game terminal consistent with the disclosed embodiments. As shown in FIG. 11, the apparatus 30 for implementing a simulated card game in a game terminal may include a game element display module 31, a card element updating module 32, and a highest value card playing character labeling module 33.

The game element display module 31 is configured to display multiple sets of game elements of the simulated card game on a game interface. Each set of game elements corresponds to one virtual character. Each set of game elements includes character elements and card elements that represent the corresponding virtual character.

The card element updating module 32 is configured to receive a card playing instruction corresponding to a virtual character, and update the card elements corresponding to the virtual character based on the received card playing instruction.

The highest value card playing character labeling module 33 is configured to, based on preset game rules and cards played by all virtual characters in a current turn, determine the virtual character that plays a highest value cards in the current turn, and label the game elements corresponding to the virtual character that plays the highest value cards, so that the virtual character that plays the highest value cards can be distinguished from other virtual characters.

The label can be a graphical label using contents, position, color, shape and texture of the graphical label to distinguish other virtual characters. Further, the label can be placed at the side or in the center of the character elements or the card elements corresponding to the virtual character.

In addition, the contents of the label may include text or graphics. For example, the graphical label may be a word “high”, an arrow pointing to the character element corresponding to the virtual character that plays the highest value cards in a current turn, or a special logo (e.g., an imperial crown) placed on the character element corresponding to the virtual character that plays the highest value cards in the current turn.

The label may also be a sound label. For example, after the first virtual character plays the cards in the current turn, if the value of the cards played by the second virtual character is higher than the value of the cards played by the first virtual character, sound (e.g., “high”) is played to inform the player the virtual character that plays the highest value cards.

The label may also be an animation. For example, after the first virtual character plays the cards in a current turn, if the value of the cards played by the second virtual character is higher than the value of the cards played by the first virtual character, an animation is played to inform the player the virtual character that plays the highest value cards. The game elements of the virtual character that plays the highest value cards can also be labeled through changing shape, size or color of the character elements or the card elements.

It can be clearly understood by persons skilled in the art that, for the purpose of convenient and brief description, for the detailed working process of the foregoing apparatus and module, references may be made to the corresponding process in the method embodiments in FIGS. 2 to 8, and details are not described herein again.

Comparing with current technologies, the method for implementing a simulated card game in a game terminal in the present disclosure can distinguish a virtual character that plays the highest value cards through labeling the game elements corresponding to the virtual character that plays the highest value cards. The method can clearly inform the game user (player) which virtual character plays the highest value cards in the current turn. Therefore, the user can quickly make a card playing decision for the next turn. The game interface is more user-friendly, and the user's interactive experience is enhanced

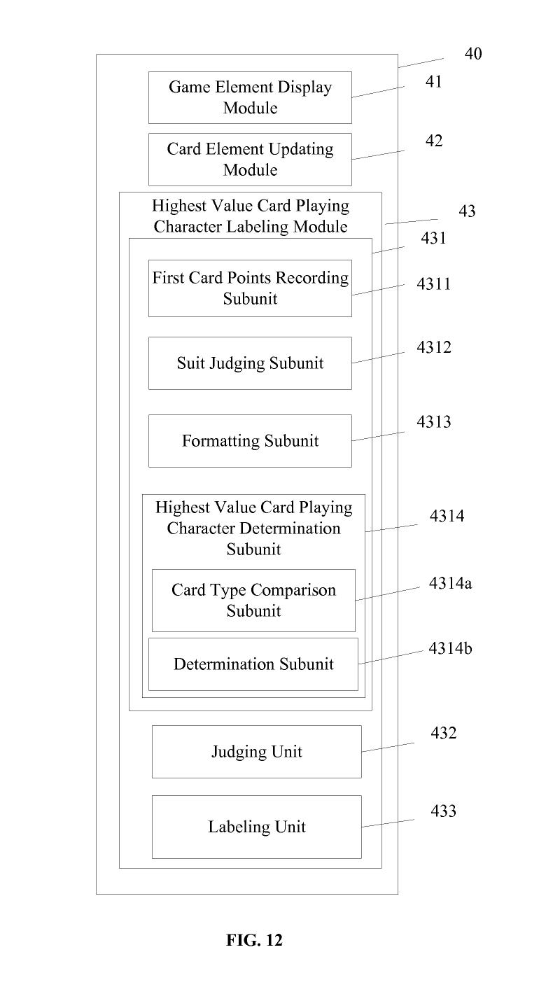

FIG. 12 illustrates a structure diagram of another exemplary apparatus for implementing a simulated card game in a game terminal consistent with the disclosed embodiments. As shown in FIG. 12, the apparatus 40 for implementing the simulated card game in the game terminal may include a game element display module 41, a card element updating module 42, and a highest value card playing character labeling module 43.

The game element display module 41 is configured to display multiple sets of game elements of the simulated card game on a game interface. Each set of game elements corresponds to one virtual character. Each set of game elements includes character elements and card elements that represent the virtual character.

The card element updating module 42 is configured to receive a card playing instruction corresponding to a virtual character, and update the card elements corresponding to the virtual character based on the received card playing instruction.

The highest value card playing character labeling module 43 is configured to, based on preset game rules and cards played by various virtual characters in a current turn, determine the virtual character that plays the highest value cards in the current turn, and label the game elements corresponding to the virtual character that plays the highest value cards.

The highest value card playing character labeling module 43 may further include a highest value card playing character determination unit 431, a judging unit 432 and a labeling unit 433.

The highest value card playing character determination unit 431 is configured to, based on the preset game rules and the cards played by various virtual characters in the current turn, determine the virtual character that plays the highest value cards in the current turn.

The highest value card playing character determination unit 431 may further include a first card point recording subunit 4311, a suit judging subunit 4312, a formatting subunit 4313 and a highest value card playing character determination subunit 4314.

The first card point recording subunit 4311 is configured to, based on preset card type, suit, and type value and card point corresponding to each card type, calculate and record card type, suit and the highest card points of the cards played by the first virtual character in the current turn.

The suit judging subunit 4312 is configured to judge whether the suit type of the cards played by a subsequent virtual character is greater than 1, judge whether the suit of the cards played by the subsequent virtual character is the same as the suit of the cards played by the first virtual character, and judge whether the suit of the cards played by the subsequent virtual character is the same as the suit of the trump cards.

The formatting subunit 4313 is configured to, based on the type of the cards played by the first virtual character, format the type of the cards played by the subsequent virtual character.

The highest value card playing character determination subunit 4314 is configured to, based on the preset game rules, determine the virtual character that plays the highest value cards.

The highest value card playing character determination subunit 4314 may include a card type comparison subunit 4314a and a determination subunit 4314b.

The card type comparison subunit 4314a is configured to compare whether the type of cards played by the subsequent virtual character matches with the type of cards played by the first virtual character. If the type of cards played by the subsequent virtual character does not match with the type of cards played by the first virtual character, the determination subunit 4314b is configured to determine that the first virtual character is the virtual character that plays the highest value cards. If the type of cards played by the subsequent virtual character matches with the type of cards played by the first virtual character, the card type comparison subunit 4314a compares the highest point of the card type with the highest type value of the cards played by the virtual characters, and then the determination subunit 4314b is configured to determine that the virtual character with the highest point cards is the virtual character that plays the highest value cards; if the highest points of cards played by the virtual characters are the same, the determination subunit 4314b is further configured to determine that the virtual character that plays the cards first is the virtual character that plays the highest value cards.

The judging unit 432 is configured to judge whether the number of virtual characters that play cards is greater than or equal to 2. If the number of virtual characters that play cards is greater than or equal to 2, the labeling unit 433 is configured to label the game elements corresponding to the virtual character that plays the highest value cards so that other virtual characters can be distinguished. If the number of virtual characters that play cards is less than 2, the labeling unit 433 does not perform a label operation.

The label can be a graphical label using contents, position, color, shape, or texture of the graphical label to distinguish other virtual characters. The label can also be a sound label and an animation label. The virtual character that plays the highest value cards can be distinguished through labeling the game elements of the virtual character by changing shape, size, or color of the character elements or the game elements.

It should be noted that, each embodiment in the specification is described in a progressive manner. The same or similar parts in the embodiments are just references to each other. Every embodiment illustrates in emphasis what is different from the other embodiments. In particular, for the apparatus embodiment, because it is basically similar to the method embodiment, the description is relatively simple, and for the relevant part, reference is just made to the part of the description of the method embodiment. The apparatus embodiment described above is merely exemplary, in which units described as separate components may be or may not be physically separated, and components shown as units may be or may not be physical units. Part of or all of the modules may be selected to achieve the objective of the solution of this embodiment according to actual requirements.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed method and apparatus for implement a simulated card game, when the web browser or other applications are running on terminal, multiple sets of game elements of the simulated card game are displayed on a game interface. A card playing instruction corresponding to one virtual character is received, and the card elements corresponding to the virtual character are updated based on the received card playing instruction. Based on preset game rules and cards played by each virtual character in a current turn, the virtual character that plays the highest value cards in the current turn is determined, and the game elements corresponding to the virtual character that plays the highest value cards are labeled, so that other virtual characters can be distinguished. The method for implementing the simulated card game on the game terminal can distinguish the virtual character that plays the highest value cards through labeling the game elements corresponding to the virtual character that plays the highest value cards. The method can clearly inform a game user (a player) which virtual character plays the highest value cards in the current turn. Therefore, the user can quickly make a card playing decision for the next turn. The game interface is more user-friendly, and the user's interactive experience is enhanced.

What is claimed is:

1. A method for implementing a simulated card game on a game terminal, comprising:
displaying multiple sets of game elements of a simulated card game on a game interface, wherein each set of game elements corresponds to a virtual character, and each set of game elements include one or more character elements and card elements that represent the corresponding virtual character;
receiving a card playing instruction corresponding to the virtual character;
based on the received card playing instruction, updating the card elements corresponding to the virtual character;
based on card game rules and cards played by virtual characters in a current turn, determining a virtual character that plays highest value cards; and
labeling the game elements corresponding to the virtual character that plays the highest value cards to distinguish other virtual characters in the current run.

2. The method according to claim 1, wherein, based on card game rules and cards played by virtual characters in a current turn, determining the virtual character that plays highest value cards further includes:
based on a preset card type, suit, type values and points corresponding to various card types, calculating and recording the card type, suit and the highest value points of the cards played by a first virtual character in the current turn;
judging whether the suit type of the cards played by a subsequent virtual character is greater than 1, wherein:
when the suit type of the cards played by the subsequent virtual character is greater than 1, the first virtual character is determined as the virtual character that plays the highest value cards; and
when the suit type of the cards played by the subsequent virtual character is not greater than 1, whether the suit of the cards played by the subsequent virtual character is the same as the suit of the cards played by the first virtual character is judged;
when the suit of the cards played by the subsequent virtual character is the same as the suit of the cards played by the first virtual character, formatting the card type of the cards played by the subsequent virtual character based on the card type of the cards played by the first virtual character and determining the virtual character that plays the highest value cards in the current turn based on preset comparison rules; and
when the suit of the cards played by the subsequent virtual character is not the same as the suit of the cards played by the first virtual character, judging whether the suit of the cards played by the subsequent virtual character is the same as the suit of the trump cards, wherein:
when the suit of the cards played by the subsequent virtual character is the same as the suit of the trump cards, formatting the card type of the cards played by the subsequent virtual character based on the card type of the cards played by the first virtual character and determining the virtual character that plays the highest value cards in the current turn based on the preset comparison rules; and
when the suit of the cards played by the subsequent virtual character is not the same as the suit of the trump cards, the first virtual character is determined as the virtual character that plays the highest value cards.

3. The method according to claim 2, wherein determining the virtual character that plays the highest value cards in the current turn based on preset comparison rules further includes:
comparing whether the type of the cards played by the subsequent virtual character matches with the type of the cards played by the first virtual character;
when the type of the cards played by the subsequent virtual character does not match with the type of the cards played by the first virtual character, determining that the first virtual character is the virtual character that plays the highest value cards; and
when the type of the cards played by the subsequent virtual character matches with the type of the cards played by the first virtual character, comparing the highest points corresponding to the card type with the highest type value of the cards played by each virtual character, wherein:
when the highest points of the cards played by various virtual characters are not the same, the virtual character whose highest points is the highest is determined as the virtual character that plays the highest value cards; and
when the highest points of the cards played by various virtual characters are the same, the virtual character that plays the cards first is determined as the virtual character that plays the highest value cards.

4. The method according to claim 1, wherein labeling the game elements corresponding to the virtual character that plays the highest value cards to distinguish other virtual characters further includes:
judging whether the number of the virtual characters that play the cards is greater than or equal to 2, wherein:
when the number of the virtual characters that play the cards is greater than or equal to 2, the game elements corresponding to the virtual character that plays the highest value cards are labeled to distinguish other virtual characters; and
when the number of the virtual characters that play the cards is not greater than or equal to 2, the game elements corresponding to the virtual character that plays the highest value cards are not labeled.

5. The method according to claim 4, further including:
labeling the game elements corresponding to the virtual character that plays the highest value cards using a graphical label; and
distinguishing the virtual character that plays the highest value cards from other virtual characters using contents, position, color, shape and texture of the graphical label.

6. The method according to claim 5, wherein the location for setting the graphical label includes:
a center of the character elements and card elements corresponding to the virtual character; and
around the character elements and card elements corresponding to the virtual character.

7. The method according to claim 6, wherein:
the contents of the graphical label include text and graphics.

8. The method according to claim 4, further including:
labeling the game elements corresponding to the virtual character that plays the highest value cards through changing shape, size and color of the character elements and the card elements.

9. The method according to claim 4, further including:
labeling the game elements corresponding to the virtual character that plays the highest value cards using a sound label.

10. The method according to claim 4, further including labeling the game elements corresponding to the virtual character that plays the highest value cards using an animation label.

11. An apparatus for implementing a simulated card game in a game terminal, comprising:
a game element display module configured to display multiple sets of game elements of a simulated card game on a game interface, wherein each set of game elements corresponds to one virtual character, and each set of game elements include one or more character elements and card elements that represent the corresponding virtual character;
a card element updating module configured to receive a card playing instruction corresponding to a virtual character, and update the card elements corresponding to the virtual character based on the received card playing instruction; and
a highest value card playing character labeling module configured to, based on preset game rules and cards played by all virtual characters in a current turn, determine the virtual character that plays highest value cards in the current turn, and to label the game elements corresponding to the virtual character that plays the highest value cards to distinguish other virtual characters in the current turn.

12. The apparatus according to claim 11, wherein the highest value card playing character labeling module further includes:
a highest value card playing character determination unit configured to, based on the preset game rules and the cards played by various virtual characters in the current turn, determine the virtual character that plays the highest value cards in the current turn, wherein the highest value card playing character determination unit further includes:
a first card point recording subunit configured to, based on preset card type, suit, and type values and card points corresponding to various card types, calculate and record card type, suit and the highest card points of the cards played by a first virtual character in the current turn;
a suit judging subunit configured to judge whether the suit type of the cards played by a subsequent virtual character is greater than 1, judge whether the suit of the cards played by the subsequent virtual character is the same as the suit of the cards played by the first virtual character, and judge whether the suit of the cards played by the subsequent virtual character is the same as the suit of the trump cards;
a formatting subunit configured to, based on the type of the cards played by the first virtual character, format the type of cards played by the subsequent virtual character; and
a highest value card playing character determination subunit configured to, based on preset comparison rules, determine the virtual character that plays the highest value cards in the current turn.

13. The apparatus according to claim 12, wherein the highest value card playing character determination subunit further incudes:
a card type comparison subunit configured to compare whether the type of cards played by the subsequent virtual character matches with the type of cards played by the first virtual character, wherein:
when the type of cards played by the subsequent virtual character does not match the type of cards played by the first virtual character, a determination subunit is configured to determine that the first virtual character is the virtual character that plays the highest value cards; and
when the type of cards played by the subsequent virtual character matches with the type of cards played by the first virtual character, the card type comparison subunit is further configured to compare the highest point corresponding to the highest value card type of the cards played by the various virtual characters, wherein:
when the highest points of cards played by the virtual characters are not the same, the determination subunit is further configured to determine that the virtual character with the highest point cards is the virtual character that plays the highest value cards; and
when the highest points of cards played by the virtual characters are the same, the determination subunit is further configured to determine that the virtual character that plays the cards first is the virtual character that plays the highest value cards.

14. The apparatus according to claim 11, wherein the highest value card playing labeling module further includes:
a judging unit configured to judge whether the number of the virtual characters that play the cards is greater than or equal to 2; and
a labeling unit configured to label the game elements corresponding to the virtual character that plays the highest value cards, wherein:
when the number of the virtual characters that play the cards is greater than or equal to 2, the labeling unit labels the game elements corresponding to the virtual character that plays the highest value cards; and
when the number of the virtual characters that play the cards is not greater than or equal to 2, the labeling unit does not label the game elements corresponding to the virtual character that plays the highest value cards.

15. The apparatus according to claim 14, wherein:
the label includes a graphical label that labels the game elements corresponding to the virtual character that plays the highest value cards; and
contents, position, color, shape and texture of the graphical label is used to distinguish the virtual character that plays the highest value cards from other virtual characters.

16. The apparatus according to claim 15, wherein the location for setting the graphical label includes:
a center of the character elements and card elements corresponding to the virtual character; and
around the character elements and card elements corresponding to the virtual character.

17. The apparatus according to claim 15, wherein:
the contents of the graphical label include text and graphics.

18. The apparatus according to claim 14, wherein:
the label includes a sound label that labels the game elements corresponding to the virtual character that plays the highest value cards.

19. The apparatus according to claim 14, wherein:
the label includes an animation label that labels the game elements corresponding to the virtual character that plays the highest value cards.

20. The apparatus according to claim 14, wherein:
the game elements corresponding to the virtual character that plays the highest value cards are labeled through changing shape, size and color of the character elements and card elements.
